(19) United States
(12) Patent Application Publication
(10) Pub. No.: US 2007/0031662 A1
(43) Pub. Date: Feb. 8, 2007

(54) Continuous textile fibers and yarns made from a spinnable nanocomposite

(76) Inventors: Eric Devaux, Sainghin-en-Weppes (FR); Severine Bellayer, Souligne-Flace (FR); Sabine Chlebicki, La Gorgue (FR); Serge Bourbigot, Villeneuve D'Ascq (FR); Antonio Fonseca, Louvain-la-Neuve (FR); Janine Al-Asswad, Nanine (BE); Janos B. Nagy, Jambes (BE)

Correspondence Address: KNOBBE MARTENS OLSON & BEAR LLP, 2040 MAIN STREET, FOURTEENTH FLOOR, IRVINE, CA, 92614, US

(21) Appl. No.: 10/555,325

(22) PCT Filed: Apr. 9, 2004
(86) PCT No.: PCT/BE04/00049

§ 371 Date: Oct. 5, 2006

(30) Foreign Application Priority Data
Apr. 9, 2003 (EP) 034470856

(51) Int. Cl. B32B 19/00

(52) U.S. Cl. 428/357

(57) ABSTRACT

The present invention is related to a multifilament continous textile yarn made by melt spinning of a nanocomposite comprising as components at least one polymer and carbon nanotubes, and to its uses, in particular in the textile industry.

### FIELD OF THE INVENTION

The present invention is related to products made from polymer nanocomposites that find their use in the textile industry, and are in particular suited to obtain fabrics or knitted pieces.

In particular, the present invention is related to multifilament continuous yarn usable in the textile industry, and made from a spinnable nanocomposite.

### STATE OF THE ART

If textile fibers may be of natural origin such as cotton, synthetic polymers such as polyester, polypropylene, polyamide or viscose, are also widely used to produce synthetic textile fibers.

In order to satisfy a market more and more demanding, new textile fibers with specific functionalities such as etancheity, electrical conductivity, anti-radiation protection, elasticity, thermal stability or fire resistance are investigated.

With this aim, different strategies have been proposed: particular production or treatment processes (of chemical or chemical type), introduction of additives, . . .

Among said different strategies, the introduction of nanoparticles as fillers such as carbon nanotubes or fullerenes or ceramics, in order to produce fibers known as “high performance fibers”, seems to be particularly promising.

Carbon nanotubes were first observed by Iijima in 1991 (S. Iijima, Nature 354 (1991) 56-58). The tubes are built up of carbon atoms arranged in hexagons and pentagons, with the pentagons concentrated in areas such as the tube ends. Typically, the carbon nanotubes consist of single-wall tubes (hereafter SWNTs) and multi-wall tubes (hereafter MWNTs).

Carbon nanotubes have revealed interesting flexibility and resistance properties to an applied stress. They are known among others as flame retardant and fire resistant components.

Spinnable composites comprising at least one polymer and carbon nanotubes as fillers, and fibers made from said composites have already been proposed in order to enhance the properties of said polymer (reinforced composites and reinforced fibers).

However, the thus far proposed composites and related fibers are not adapted to textile applications. Kearns and Shambough (Journal of Applied Polymer Science, 2002, vol 86: 2079-2084) for instance describe a polypropylene fiber (not a yarn) containing about 1 wt % of single wall carbon nanotubes (SWNTs). The monofilament fiber with a presumable diameter of 0.8 mm after drawing is, however, not directly suited for textile applications.

The production of textile fibers in general requires a much smaller fiber diameter and requires said fiber to have particular mechanical properties at the same time. Most of the thus far proposed fibers present some defects at the nanoscopic level, said defects resulting from a non homogenous dispersion of the nanotubes in the composite, which naturally tend to agglomerate with each other. Such agglomerates are detrimental to product quality in case their size is considerable in view of the fiber diameter. These agglomerates then lead to a product of inhomogeneous quality, which risks breaking, because the agglomerates introduce points of weakness. Solutions that have been offered thus far for a more homogeneous dispersion of nanotube charges in a polymer, are either too complex, comprise too many steps, require the presence of possibly noxious substances, and/or proved non sufficient for the envisaged textile applications.

A homogenous dispersion of nanotubes at the nanoscopic level is supposed to be critical as well for the transfer of the technical characteristics of the carbon nanotubes, like flame retardation, to the polymer composite and to the resulting fiber.

In other words, the problem of providing high quality continuous multifilament yarns of relatively low diameter, i.e. lower than about 200 μm, from nanocomposites comprising at least one polymer and carbon nanotubes as fillers remained unsolved hitherto.

### AIMS OF THE INVENTION

The present invention aims to provide multifilament continuous textile yarns and fabrics, made from spinnable nanocomposites based on polymers that are charged with carbon nanotubes.

In particular, the present invention aims to provide multifilament continuous textile yarns and fabrics presenting flame retardant properties, for applications in textile industry.

It is a further aim of the invention to provide an easy, environmental friendly process to prepare such textile fibers, yarns and tissues on an industrial basis, whereby the nanotubes contained in the composite are well dispersed, resulting in a yarn with good mechanical properties and a homogeneous quality.

### DEFINITIONS

In the present description, it is meant by “fiber” or “textile fiber” the product directly obtained by spinning of a composite. A “fiber” consists of one monofilament. The term “textile fiber” refers to the ability of a fiber to be used in industrial textile processes, for instance to make a fabric or a non-tissue.

It is meant by “continuous textile fiber” a textile fiber having a more or less infinite length. With an infinite length is meant that the fiber when spun is at least 50 cm to a few meters long, more preferably at least a few hundred meters long, most preferably at least several kilometers in length. Linen and cotton yarn is produced from discontinuous filaments, which in contrast to the above, are only 5 to 6 cm long in general.

It is meant by “yarn” or “textile yarn” an assembly of several monofilaments or fibers into a continuous strand. This strand often contains two or more plies that are composed of carded or combed fibers twisted together by spinning, filaments laid parallel or twisted together.

It is meant by “composite” a product comprising at least one polymer and carbon nanotubes as fillers.

It is meant by “nanocomposite” a composite wherein carbon nanotubes are homogenously dispersed at the nanoscopic level.

The words “fabric” and “non-tissue” have the same definition as known by the man skilled in the art and result from processes performed on yarns as known by the man skilled in the art.

It is meant by “nanofiller” any filler or charge other than carbon nanotubes and having a diameter of about 1 to several nanometers as known by the man skilled in the art.

### SUMMARY OF THE INVENTION

The present invention is directed to continuous textile fibers comprising as components at least one polymer and carbon nanotubes.

In these fibers, nanotube charges are more or less homogeneously dispersed at the nanoscopic level, so that yarn can be produced from these fibers that is strong, homogeneous in quality and that in addition has advantageous properties, such as enhanced thermal and fire stability, that are interesting for industrial textile applications.

An optimal dispersion of the nanocharges within the polymer in the present invention was mainly obtained by functionalization of the nanotubes and/or by adapting the thermo-mechanical extrusion conditions, combined with violent mixing of the ingredients. Functionalization results in mutual repulsion of the nanotubes thereby preventing formation of larger agglomerates. Extrusion and mixing conditions can be chosen such that charges will be separated mechanically. It is important to find the right balance, id est to obtain sufficient dispersion of charges but to avoid degradation of the polymer by too severe process conditions.

An example of applied process conditions for a polypropylene-based nanocomposite prepared in a particular twin screw extruder is provided in the experimental part below. The conditions needed for a good dispersion of charges are, however, not universal and depend largely on the polymer and equipment used. It lies, however, within the normal skills of an artisan to define experimentally the optimal process conditions according to the materials and equipments used.

The fibers according to the invention preferably have a diameter in the range of about 10 μm to about 50 μm, preferably in the range of about 20 μm to about 40 μm.

The polymer used to prepare the nanocomposite may be selected from the group consisting of thermoplastic polymers, polyolefins, vinylic polymers, acryl-nitrile polymers, polyacrylates, elastomers, fluoro-polymers, thermoplastic polycondensates, duroplastic polycondensates, silicon resins, thermoplastic elastomers, co- and ter-polymers, grafted polymers and mixtures thereof.

The carbon nanotubes may be SWNTs (single-wall carbon nanotubes), MWNTs (multiple-wall carbon nanotubes) and/or any mixture thereof.

The carbon nanotubes may be pure, partly purified or crude nanotubes.

According to an embodiment of the invention, the carbon nanotubes are functionalized (i.e. a new function or group is added) to obtain mutual repulsion and to prevent agglomerate formation at the microcopic level. Functionalization may be achieved through ball-milling or by a functionalization in solution.

According to another embodiment of the invention, the fiber comprises carbon nanotubes with adjusted surface properties, such as the MWNTs-2 carbon nanotubes (see infra). Adjusted surface properties may be obtained after drying by liophylisation, drying under vacuum at high temperature (i.e. about 500° C.) or drying by azeotrope distillation performed on crude and/or (partly) purified nanotubes samples. A post-synthesis heating will result in a further crystallization of the carbon nanotubes, whereby part of their defects may be removed and whereby their surface properties are changing.

Preferably the carbon nanotube to polymer weight ratio varies from about 0.01 to about 100 and preferably between about 0.1 and about 10.

The fibers according to the invention in addition to the polymer(s) and carbon nanotubes may further comprise at least one nanofiller, preferably in an amount of about 1 to about 70 wt %, more preferably in an amount of about 10 to about 50 wt %.

The fibers according to the invention may be converted into a continuous multifilament yarn consisting of a set of continuous fibers as defined above.

A yarn according to the invention comprises at least 20 continuous fibers, preferably at least 40, more preferably at least 80 fibers. A preferred yarn is one that comprises 80 continuous fibers and has a linear weight of approximately 1100 dtex. A particularly preferred yarn is comprised of 80 parallel monofilaments of each about 10 microns to about 50 microns, the microfilaments being held together by a textile size as known in the art.

Another aspect of the invention concerns fabrics made from the above continuous textile yarn or the continuous textile fibers.

The inventions also is related to processes for obtaining a continuous textile fiber and/or a continuous multifilament yarn and/or a fabric according to the invention. The process according to an embodiment of the invention comprises the step of melt spinning a nanocomposite comprising at least one polymer and carbon nanotubes with previously adjusted surface properties.

In this process, the nanocomposite preferably is submitted to an extrusion pre-step at a rotation extrusion speed in the range of about 200 rpm to about 600 rpm. For polypropylene extrusion, the preferred extrusion speed in this pre-step is in the range of about 300 to about 400 rpm when combined with an inlet temperature in the range of about 200° C. to about 260° C. When opting for higher extrusion speeds, the optimal inlet temperature in general will be lower. Another parameter which has an influence on the optimal conditions is the length of the screws, which depends on the type of extruder used. A person skilled in the art is able to define optimal process parameters.

During the melt spinning step, which is characterised by a material flux, the nanocomposite is preferably speeded up to a speed comprised between about 1000 m/min and about 6000 m/min and oriented in the material flux. In a preferred embodiment of the invention, concerning PP-thin MWNTs based nanocomposites, the nanocomposite was speeded up to about 4500 m/min and oriented in the main direction of the material flux.

A last aspect of the invention concerns the use of the continuous fibers, the multifilament continuous textile yarn and/or the fabrics of the invention
as anti-fire protection structures and/or as flame retardant materials;
as reinforcement materials;
as thermal conductive materials;
in cloth, in building or vehicle structures;
in carpets, preferably in groundsheets, carpet back-layers and/or carpet front-layers.

### SHORT DESCRIPTION OF THE DRAWINGS

FIG. 1 contains a representation and pictures of woven ribs. a) Representation of a woven rib; b) Picture of the pure PP fabrics; c) Picture of the black PP/MWNTs-2 fabrics.

FIG. 2 contains TG results. a) TG curves for pure PP, PP/MWNTs-2 and MWNTs-2 materials; b) Curve of weight difference between theoretical and practical TG curve for pure PP, PP/MWNTs-2 and MWNTs-2 materials.

FIG. 3 contains cone calorimeter results. a) RHR curves for PP and PP/MWNTs-2 fabrics at 35 kW/m²; b) THE curves for pure PP and PP/MWNTs-2 fabrics at 35 kW/m².

FIG. 4 contains smoke production results. a) CO₂ production curves for pure PP and PP/MWNTs-2 fabrics at 35 kW/m²; b) Co production curves for pure PP and PP/MWNTs-2 fabrics at 35 kW/m².

FIG. 5 contains volume of smoke production (VSP) curves for pure PP and PP/MWNTs-2 fabrics at 35 kW/m².

The invention will now be described in further details in the following examples and embodiments, by reference to the enclosed drawings. The examples and embodiments, however, are not in any way intended to limit the scope of the invention as claimed.

### DETAILED DESCRIPTION OF THE INVENTION

I. Description of the Starting Materials

A) Polymers

The polymers that can be used are selected from polyolefins (like polypropylene (further abbreviated as PP), polyethylene (PE), etc.), thermoplastic polymers (like polystyrene, etc.), vinylic polymers (like PVC or PVDF), acryl-nitrile polymers, polyacrylates, elastomers, fluoro polymers, thermoplastic polycondensates (like PA, PC, PETP), duroplastic polycondensates, silicon resins, thermoplastic elastomers, co- and ter-polymers, grafted polymers and also their blends. All these materials are well known in the art.

A summary of suitable polymers can be found in: Hans Dominghaus “Die Kunststoffe und ihre Eigenschaften” 2 Auflage, VDI-Verlag, Seite VII bis XI.

B) Nanotubes

The carbon nanotubes may be single-wall carbon nanotubes (SWNTs), multiple-wall carbon nanotubes (MWNTs) or their mixtures.

These carbon nanotubes may be either pure, partly purified, or crude.

Crude nanotubes contain the spent catalysts and other forms of carbon that are by-products of the nanotube synthesis. These by-products include amorphous carbon, pyrolytic carbon, carbon nanoparticles, nanohorns, fullerene peapods, carbon onions, fullerenes, metal nanoparticles encapsulated in carbon, carbon fibres. Examples of spent catalysts are for instance oxides, mixed oxides, aluminosilicates, zeolites, oxycarbides, mixed oxycarbides, carbonates, metal hydroxides, metal nanoparticles, etc.

Partly purified nanotubes contain by-products that could not be eliminated during the purification process.

Crude and purified nanotubes were obtained from Nanocyl S. A. (Belgium).

In order to obtain nanotubes of adjusted surface properties, which promotes their dispersion in the polymer matrices, complementary treatments such as drying by liophylisation, drying under vacuum at high temperature (i.e. about 500° C.) or drying by azeotrope distillation, can be performed on the crude and/or the (partly) purified nanotubes samples.

Functionalization of crude or purified carbon nanotubes such as functionalization by ball-milling or functionalization in solution can also be envisaged with this aim.

II. Preparation of the Spinnable Nanocomposites Containing Carbon Nanotubes

Melt Process

Spinnable nanocomposites comprising at least one polymer and carbon nanotubes as fillers in the present example were prepared according to a melt spinning process, preferably as disclosed hereafter.

Melt spinning is a fast process which in general avoids the use of toxic and/or explosives solvents. Melt spinning in general requires the use of polymers with a relatively low molecular mass (examples given below). If not, the melt is too viscous and requires the addition of a solvent which slows down the process a bit because the solvent needs to be removed by evaporation at the end of the process.

It is thus preferred to use polymers of low molecular mass. In general, fibers from which clothes and mainstream textile are prepared, are fibers with mechanical properties described as “medium” in the art. They can be prepared from polymers with a relatively low molecular mass. If one wants to prepare fibers known as “high performance” fibers in the art, polymers with a higher molecular mass need to be used, which requires the presence of a solvent to reduce the melt viscosity. This is known to a person skilled in the art.

Here, direct melt extrusion was used to blend the polymer and the carbon nanotubes and to simplify the yarn making process. More precisely, a Rheomex PTW-16/25p twin screw extruder from ThermoPrism, was used to melt and mix the nanotubes with the polymer.

The extruder comprised five heating zones, in which the temperature was independently fixed (i.e. from about 200° C. to about 260° C. for PP). The rotational screw speed rate was fixed at preferably about 300 rounds/min (rpm), to have a high shear stress, which causes the production of well-dispersed carbon nanotubes.

For the extrusion of PP-based nanocomposites in the above extruder, the inlet temperature was set at about 200° C. to about 260° C. and the rotational screw speed was fixed at about 300 to about 400 rpm (400 rpm being the maximum of the extruder type used). There are extruders on the market with which a maximal speed of about 600 rpm can be obtained. In general, preferably a rotation extrusion speed in the range of about 200 rpm to about 600 rpm is used in the extrusion pre-step, wherein granules comprised of polymer and carbon nanotubes are prepared, which are then further processed and converted into continuous yarn.

The spinnable nanocomposite obtained in the present example was then either pelletised or directly introduced in the spinning machine. When pellets were made, they were further processed in the spinning machine.

III. Preparation of the Yarns and Fabrics

During the melt spinning process, the molten nanocomposite was forced through a die containing 80 circular or trilobal holes with diameters lower than 200 μm.

The nanocomposite in the form of a filament was then speeded up to about 4500 m/min and oriented in the main direction of the material flux. This orientation was shown to promote the ultimate properties of the multifilament continuous textile yarn finally obtained. The high speed at which the process is carried out, comparatively to the speed in classical wet spinning processes (a few m/min) may also contribute to said result.

A) Melt Spinning Process

A melt spinning machine called Spinboy I manufactured by Busschaert Engineering was used.

The solid pellets of nanocomposite were introduced in a single screw extrusion system composed of five heating zones (from about 180° C. to about 230° C.). The molten material was then injected through the dies, in this particular case eighty holes with preferably circular shapes, using a volumetric pump at a preferred flow of about 100 cm³/min (i.e. for pellets of PP/thin MWNTS). Systems with less or with more holes may be used equally well.

On the outlet side of the dies, a beam of monofilaments was recovered and condensed into one multifilament.

The multifilament was covered with a coating (comprising a lubricant with various additives) and rolled up on two heated rolls with different speeds (S1 and S2) to ensure a good drawn. The theoretical drawing of multifilament is given by the ratio E=S2/S1. Preferably, E is comprised between 2 and 4 for polypropylene multifilament. Preferably, E=2 for PP/thin MWNTs multifilament. The optimal E-value depends on the length of the polymer macromolecules. In general, the E-value (measure for the level of drawing) is inversely proportional to the length of the macromolecules.

Finally, the multifilament was wound on a third roll with the same speed as the second roll.

To improve the cohesion of the final yarn, preferably torsion was applied to the yarn. (Torsion was applied to the PP/thin MWNTs yarn.)

The continuous multifilament thus obtained (i.e. the PP/thin MWNTs yarn in this particular case) exhibited a mass of approximately 1100 dtex (g for 10,000 m).

B) Production of the Fabrics

The multifilament continuous textile yarns can be transformed in textile surfaces by conventional weaving or knitting or non woven techniques. The textile surfaces thus obtained will combine the technical properties of nanocomposite fibres and a textile hand.

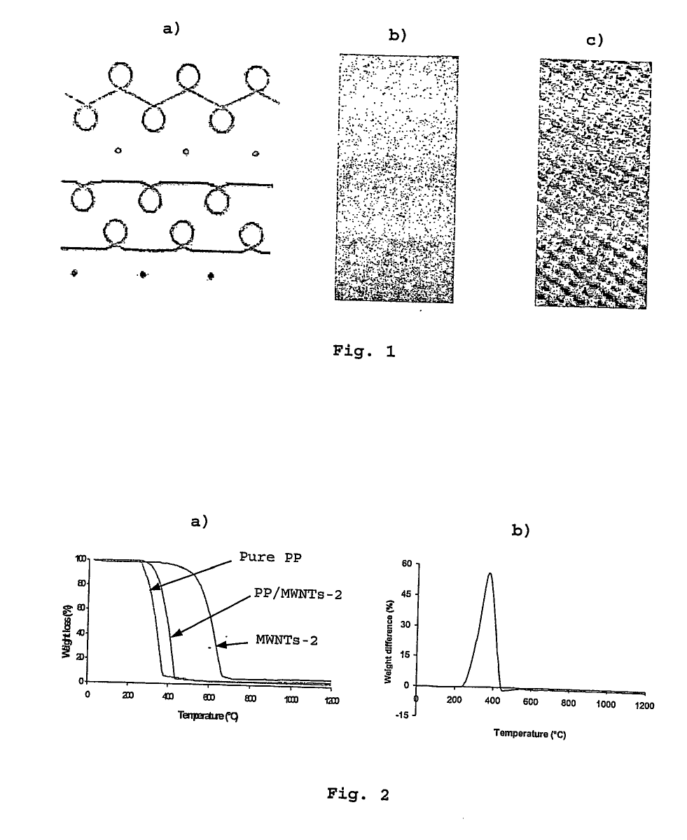

In one embodiment of the present invention, two multifilament continuous textile yarns were knitted and woven together using a rectilinear machine gauge 7 supplied by Shima Sheiki, to form a knitted fabric corresponding to a woven rib of preferably about 1300 g/m² (see e.g. FIGS. 1b and 1c for PP and PP/thin MWNTS). This fabric exhibited a particularly good behavior, namely because it was not rolling on itself, and a high square meter weight, that allows a good reproducibility with the cone calorimeter.

IV. Measure of the Properties of the Composite Materials

A) TGA Analysis

Description of the Tests:

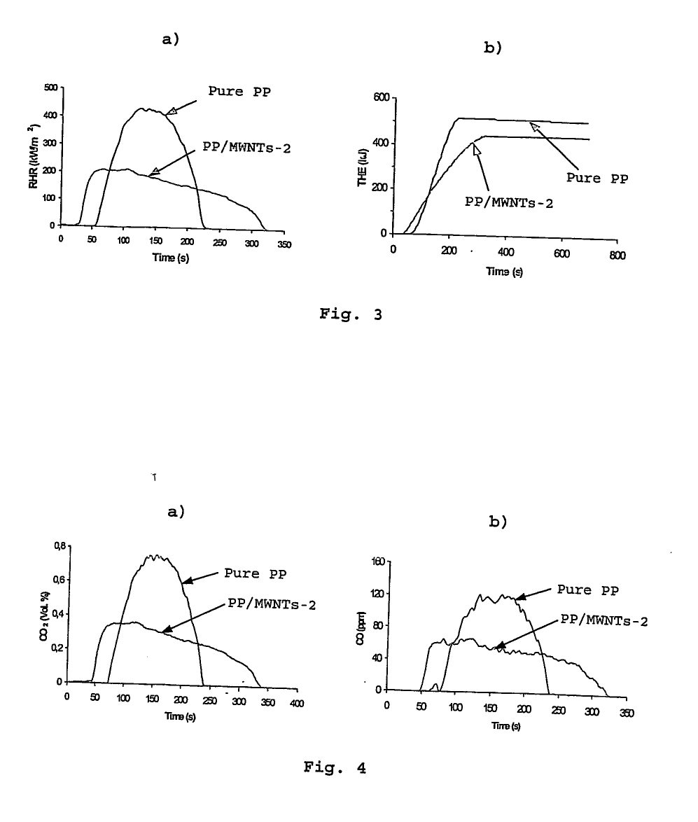

Thermogravimetric analysis was performed on a Netzsch STA449C. Measurements were carried out under an air flow, samples (about 10 mg) were heated at a rate of about 10° C./min from about 20° C. to about 1200° C. in Pt—Rh pan. The curves of weight loss and of weight difference were computed. The weight difference between the experimental and theoretical TG curves was computed as disclosed in literature (S. Bourbigot et al., Polym. Deg. Stab. 75 (2002) 397-402), in order to highlight possible interactions occurring between nanotubes and polymer (i.e. FIG. 2b for PP).

Results:

A spinnable nanocomposite comprising polypropylene (PP) as polymer and about 1 wt % of purified thin MWNTs carbon nanotubes with adjusted surface properties (hereafter called MWNTs-2) was prepared. A continuous multifilament yarn and a fabric were then prepared from said nanocomposite as described above.

The multifilament yarn thus obtained comprised 80 monofilaments and had a linear weight of approximately 1100 dtex (i.e. each monofilament has a weight of approximately 13.75 g per 10 kilometers).

It should be noted that the surface properties of the purified thin MWNTs in the present case were adjusted for better compatibility with PP by heating under vacuum at about 500° C.

The properties of the obtained fabric were compared to the ones of either a pure PP fabric or a MWNTs-2 composition.

TGA analysis of said different samples is presented in FIG. 2a.

As can be seen in the TG curves of FIG. 2a, the composition of MWNTs-2 carbon nanotubes was thermally stable up to about 450° C., and then started to degrade. The thermal behavior of the PP fabric and the behavior of the PP/MWNTs-2 fabric were similar up to about 235° C., then, the PP fabric started to degrade. It was not immediately the case for the PP/MWNTs-2 fabric. Indeed, the PP/MWNTs-2 fabric started to degrade at about 300° C. and, thus exhibited a better thermal stability than the pure PP fabric due to the presence of the carbon nanotubes.

Interactions, between the MWNTs-2 and the PP, were highlighted during degradation, thanks to the curve of difference weight of the three materials (FIG. 2b). That curve shows a great stabilization of the blend between about 250° C. and about 450° C. which implies great interactions between the polymer matrix and the nanotubes. Before, and after this stabilization no interaction was observed. This stabilization behavior is important and promising for flame retardant properties because fire processes depend on the degradation reaction occurring, both in the condense phase and the gas phase.

It has been observed that during the combustion of the PP/MWNTs-2 fabric, formation of a network in the degradation residue, due to the accumulation of carbon nanotubes could take place. This network insulated the underlying materials, slowed the mass loss rate by decomposition products and could thereby explain the flame retardant behavior.

B) Cone Calorimeter Analysis

Description of the Experiments:

The cone calorimeter experiments were performed on a Stanton Redcroft equipment with an external heat flux at 35 kW/m². It was possible to simulate the fire conditions, and determine the main fire properties that are rate of heat release (RHR), total heat release (THE), time to ignition, CO and CO₂ production and the volume of smoke production (VSP).

Results:

a) RHR (Rate of Heat Release) Results

FIG. 3a shows the rate of heat release of the pure PP and PP/MWNTs-2 fabrics. In that figure, a great drop of RHR values was observed for pure PP to PP/MWNTs-2, confirming the good behavior expected.

The time to ignition for the PP fabrics occurred at 59 s and the maximum RHR value was 450 kW/m² at 135 s, while, for the PP/MWNTs-2 fabrics, the time to ignition occurred to 38 s and a plateau was observed at 200 kW/m² between 50 and 100 s, then values went down to 0.

It means that the maximum RHR value was lowered by 50% for a fraction of nanotubes of only 1 wt %.

The flame retardant behavior was due to the carbon nanotubes that possibly acted like a barrier to prevent degradation products from passing in the gas phase. The amount of small, volatile polymer pyrolysis fragments, or fuel available for burning was reduced in the gas phase, and thus, the amount of heat released.

As can also be observed in FIG. 3a, the maximum value of RHR curve was lowered for the PP/MWNTs-2 fabric but the peak width was increased.

b) THE (Total Heat Evolved) Results

FIG. 3b represents the total amount of heat released during, burning values for PP and PP/MWNTs-2 fabrics. The THE value decreased with the nanotubes loading from 510 kJ for the pure PP to 435 kJ for the PP/MWNTs-2 fabrics. Moreover, the time to reach the maximum value was 90 s longer for the PP/MWNTs-2 fabrics, in spite of its shorter time to ignition.

Thus, the heat release, which is considered as the most critical property characterizing a fire, decreased and slowed with the nanotubes content.

c) Other Results on VSP (Volume of Smoke Production) and CO and CO₂ Production:

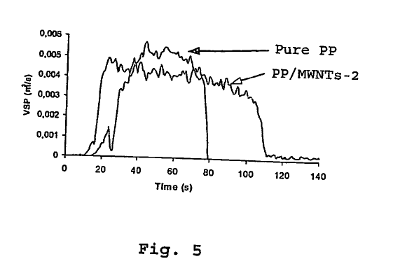

Even though the RHR stays the most important flame parameter, the volume of smoke production (VSP), and the CO and CO₂ production are the other parameters to be considered for the characterization of a fire. Said parameters were also measured for the different samples and the results are presented in FIGS. 4a, 4b, and 5.

As can be seen in FIG. 4, the rate of CO₂ and CO production was lower by 50% for the PP/MWNTs-2 sample compared to the pure PP sample.

As shown in FIG. 5, the VSP did not display such decrease, but an improvement could be noticed.

Therefore, the results obtained on both CO and CO₂ production and VSP confirm the good flame retardant behavior observed for the PP/MWNTs-2 sample in the RHR results.

C) Transmission Electron Microscope (TEM) Analysis

The dispersion of the nanotubes in the nanocomposite was studied by transmission electron microscopy (TEM) with a Philips Tecnal T10 apparatus. For analysis, the nanocomposite samples were cut into very thin slices (about 80 nm) by an ultra-microtome. Then, the slices were deposited on conventional TEM grids.

All the samples presented a relatively homogeneous dispersion of the nanotubes in the polymer matrix, thereby preventing the appearance of defects normally due to agglomerates in the resulting fiber and the risk of breakage during drawing.

In summary, multifilament continuous textile yarns and fabrics as obtained in the present invention by melt spinning of a nanocomposite comprising at least one polymer and carbon nanotubes as filler exhibit enhanced thermal and fire stability interesting for industrial textile applications.

The results obtained for PP/MWNTs-2 knitted fabrics suggest that said products could be used as anti-fire protection material and/or as flame retardant materials in structures such as buildings, in home furniture (carpets) or in clothes, because the most critical parameter defining a fire, that is the heat release, is considerably decreased comparatively to a fabric made of pure PP (50% decrease). In the same way, the other characteristics of fire properties (i.e. CO and CO₂ production and on VSP) also reveal flame retardant properties for the fabrics made of multifilament continuous textile yarns.

The products of the invention could be of value for other industrial applications such as:
use of the yarn and/or the fabric as thermal and/or electrical conductive materials;
use of the yarn and/or the fabric in electromagnetic shielding devices and/or for other radiation (i.e. UV, IR) absorption applications.

1. A continuous textile fiber comprising as components at least one polymer and carbon nanotubes.

2. The fiber according to claim 1, having a diameter in the range of about 10 μm to about 50 μm.

3. The fiber according to claim 1, wherein the polymer is selected from the group consisting of thermoplastic polymers, polyolefins, vinylic polymers, acryl-nitrile polymers, polyacrylates, elastomers, fluoro-polymers, thermoplastic polycondensates, duroplastic polycondensates, silicon resins, thermoplastic elastomers, co- and ter-polymers, grafted polymers and mixtures thereof.

4. The fiber according to claim 1, wherein the carbon nanotubes are selected from the group consisting of SWNTs, MWNTs and mixtures thereof.

5. The fiber according to claim 4, wherein the carbon nanotubes are pure, partly purified or crude.

6. The fiber according to claim 5, wherein the nanotubes have adjusted surface properties.

7. The fiber according to claim 6, wherein adjusted surface properties are obtained after drying by liophylisation, drying under vacuum at high temperature, preferably at 500° C., or drying by azeotrope distillation performed on crude and/or (partly) purified nanotubes samples.

8. The fiber according to claim 1, wherein the carbon nanotubes are functionalised.

9. The fiber according to claim 8, wherein functionalization is functionalization by ball-milling or functionalization in solution.

10. The fiber according to claim 1, wherein the carbon nanotube to polymer weight ratio varies from about 0.01 to about 100 and preferably between about 0.1 and about 10.

11. The fiber according to claim 1, further comprising at least one nanofiller, preferably in an amount of about 1 to about 70 wt %.

12. A continuous multifilament yarn consisting of a set of continuous fibers according to claim 1.

13. A yarn according to claim 12, comprising at least 20 continuous fibers, preferably at least 40, more preferably at least 80.

14. A yarn according to claim 13, comprising 80 continuous fibers and having a linear weight of approximately 1100 dtex.

15. A fabric made of the continuous textile yarn or the continuous textile fiber as defined in claim 1.

16. A process for obtaining a continuous textile fiber and/or a continuous multifilament yarn and/or a fabric according to any one of the preceding claims, comprising the step of melt spinning a nanocomposite comprising at least one polymer and carbon nanotubes with previously adjusted surface properties.

17. A process according to claim 16, comprising the nanocomposite is submitted to an extrusion pre-step at a rotation extrusion speed in the range of about 200 rpm and about 600 rpm.

18. A process according to claim 16, wherein during the melt spinning step, which is characterised by a material flux, the nanocomposite is speeded up to a speed comprised between about 1000 m/min and about 6000 m/min and oriented in the material flux.

19. (canceled)

20. (canceled)

21. (canceled)

22. (canceled)

23. (canceled)

24. A process according to claim 17, wherein during the melt spinning step, which is characterised by a material flux, the nanocomposite is speeded up to a speed comprised between about 1000 m/min and about 6000 m/min and oriented in the material flux.

25. Continuous fiber, as claimed in claim 1, used as anti-fire protection structures and/or as flame retardant materials.

26. Multifilament continuous textile yarn, as claimed in claim 12, used as reinforcement materials.

27. Multifilament continuous textile yarn, as claimed in claim 12, used as thermal conductive materials.

28. Multifilament continuous textile yarn, as claimed in claim 12, used in clothes, in building or vehicle structures.

29. Multifilament continuous textile yarn, as claimed in claim 12, used in carpets, preferably in groundsheets, carpet back-layers and/or carpet front-layers.
